(19) United States
(12) Patent Application Publication
(10) Pub. No.: US 2010/0138168 A1
(43) Pub. Date: Jun. 3, 2010

(54) APPARATUS AND A METHOD OF MEASURING THE FLOW OF A FLUID

(76) Inventors: Bruno Pinguet, Lormes (FR); Bernard Theron, Aberdeen (FR); Andrew Parry, Bourg la Reine (FR)

Correspondence Address: SCHLUMBERGER OILFIELD SERVICES, 200 GILLINGHAM LANE, MD 200-9, SUGAR LAND, TX, 77478, US

(21) Appl. No.: 12/626,991

(22) Filed: Nov. 30, 2009

(30) Foreign Application Priority Data
Dec. 1, 2008 (EP) 08170400.9

(51) Int. Cl. G01F 1/44

(52) U.S. Cl. 702/47; 73/861.63

(57) ABSTRACT

An apparatus and method for measuring a mass flow rate of a multi-phase fluid flowing through a conduit. The apparatus includes a differential pressure element located in the conduit, wherein a first differential pressure measurement device is in communication with the multi-phase fluid between a first and second position across the differential pressure element and is able to measure a first fluid differential pressure. A second differential pressure measurement device is in communication with the multi-phase fluid between a third and fourth position across the differential pressure element and is able to measure a second fluid differential pressure. A processor is in communication with the first and second differential pressure measurement devices, and is able to calculate the Reynolds number and discharge coefficient using the first and second fluid differential pressures. The processor is also capable of calculating the mass flow rate by using the Reynolds number and discharge coefficient.

### CROSS-REFERENCE TO RELATED APPLICATION

The present application is based on and claims priority to European Patent Application No. EP08170400, filed Dec. 1, 2008.

### TECHNICAL FIELD

This invention relates to an apparatus and a method of measuring the mass flow rate of a fluid. In particular, the present invention relates to a flow meter apparatus and a method of measuring the mass flow rate of a fluid particularly for use in measuring the mass flow rate of a multi-phase fluid flow.

### BACKGROUND ART

The present invention generally relates to flow rate measurements using differential pressure based flow meters with applications in the oil and gas, as well as food industries, but with particular application to multi-phase fluid flow and heavy oil fluid flow.

The standard ISO 5167 describes the manufacture, application and installation requirements of differential pressure based flow measurement devices. Typically different types of measurement devices include an orifice plate, a nozzle and a venturi tube which are inserted in conduits having a circular cross-section. The venturi tube has the advantage of low overall pressure loss offered and tolerance to erosion and particles flowing through the venturi tube.

In the art there are many types of venturi flow meters having different configurations, flow regimes and multi-phase applications. Venturi flow meters are also used in gas-condensate or wet-gas flows. Multiple differential pressure sensors have been employed to infer the split between the gas and the wet part of the gas (i.e. condensate).

U.S. Pat. No. 7,293,471 describes a flow meter for measuring fluid mixtures. The present invention is directed to a flow meter that obtains the individual flow rates of gas, liquid hydrocarbons, and water in a predominantly gas-containing flowing fluid mixture. One of the elements of the flow meter comprises a double differential pressure generating and measuring structure. Using a calibration model, the ratio of the two differential pressure measurements is used to determine the Lockhart-Martinelli parameter. The Lockhart-Martinelli parameter expresses the liquid fraction of a flowing fluid.

U.S. Pat. No. 6,502,467 describes a system for measuring multi-phase flow using multiple pressure differentials. The present invention is directed to a method and system for measuring a multi-phase flow in a pressure flow meter. An extended throat venturi tube is used and pressure of the multi-phase flow is measured at three or more positions in the venturi, which define two or more pressure differentials in the flow conduit. The differential pressures are then used to calculate the mass flow of the gas phase, the total mass flow, and the liquid phase.

U.S. Pat. No. 6,935,189 describes an apparatus and method for measuring multi-phase flow using at least two venturis and a pressure dropping means located between the two venturis. The two venturis in combination with a water fraction meter are used to determine the mass flow of the gas phase, the oil, and the water.

One of the problems with devices and methods described in the cited references is that they do not measure with sufficient accuracy the mass flow rate of multi-phase fluids, particularly when dealing with high viscosities. There are also other problems with the above devices and methods.

One of the advantages of this invention is that it is able to measure the mass flow rate with more sufficient accuracy than the existing devices and methods currently found in the art. A further advantage of the present invention is that it can measure the mass flow rate sufficiently accurately with multi-phase fluids having high viscosities. The present invention overcomes these problems and provides an improved method and apparatus in light of the prior art.

A further advantage of the apparatus and method of determination of the mass flow rate of a fluid flowing through a conduit of the present invention is that it allows the calculation of the mass flow rate, qₘ, of multi-phase fluid especially in high viscous fluids without the need for sampling and measuring the viscosity. It is also advantageous over the prior art because it does not require an iterative method by which to determine the mass flow rate, but provides a direct method for the determination of the mass flow rate.

### BRIEF SUMMARY OF THE DISCLOSURE

A first aspect of the present invention provides an apparatus for determination of the mass flow rate of a multi-phase fluid flowing through a conduit, the apparatus comprising: a differential pressure element being located in the conduit; wherein a first differential pressure measurement device is in communication with the multi-phase fluid between a first position and a second position across the differential pressure element and is able to measure a first fluid differential pressure; a second differential pressure measurement device is in communication with the multi-phase fluid between a third position and a fourth position across the differential pressure element and is able to measure a second fluid differential pressure; a processor is connected to the first and second differential pressure measurement devices, the processor being able to calculate the Reynolds number and the discharge coefficient using the first and second fluid differential pressures measured by the connected first and second differential pressure measurement devices, respectively; and the processor being able to calculate the mass flow rate by using the calculated Reynolds number and discharge coefficient.

The differential pressure element may comprise a venturi having a converging section, a throat section and a diverging section. The venturi may generally be described as a short tube with a constricted throat used to determine fluid pressures and velocities by measurement of differential pressures generated at the throat as a fluid traverses the tube.

In one form of the present invention there may be more than two differential pressure measurement devices.

The first position of the first differential pressure measurement device may be upstream of the venturi. The second position of the first differential pressure measurement device may be at the throat section of the venturi.

The third position of the second differential pressure measurement device may be at the throat section of the venturi.

In one form of the present invention the fourth position of the second differential pressure measurement device may be between the throat section and the diverging section of the venturi. In another form of the present invention the fourth position of the second differential pressure measurement device may be between the throat section of the venturi and the diverging section of the venturi downstream of the throat section.

Further according to the present invention the third position of the second differential pressure measurement device may be between upstream of the venturi and the converging section situated upstream of the throat of the venturi. In this form of the present invention the fourth position of the second differential pressure measurement device may be at the throat section of the venturi.

Even further according to the present invention the third position of the second differential pressure measurement device may be upstream of the venturi. In this form of the present invention the fourth position of the second differential pressure measurement device may be between the throat section and the diverging section of the venturi. Alternatively, in this form of the present invention the fourth position of the second differential pressure measurement device may be between the throat section of the venturi and the diverging section of the venturi downstream of the throat section.

Further according to the present invention the venturi may be a V-cone, a wedge or a nozzle.

A second aspect of the present invention provides an in-line method for determination of the mass flow rate of a multi-phase fluid flowing through a conduit, the method comprising: positioning a differential pressure element, a first pressure differential pressure measurement device and a second differential pressure measurement device in the conduit; measuring a first differential pressure between a first position and a second position across the differential pressure element by means of the first differential pressure measurement device; measuring a second differential pressure between a third position and a fourth position across the differential pressure element by means of the second differential pressure measurement device; processing the first differential pressure and the second differential pressure measured by means of a processor in communication with the first and the second differential pressure measurement devices; calculating the Reynolds number and the discharge coefficient by means of the processor; and calculating the mass flow rate by means of the processor, and by using the calculated Reynolds number and discharge coefficient.

Preferably, method allows the determination of the mass flow rate of a multi-phase fluid flowing through a conduit to be calculated directly by the processor.

Further according to the present invention, the method may include measuring the density of the multi-phase fluid. In one aspect of the present invention, the density of the multi-phase fluid may be measured by gamma ray attenuation as described in U.S. Pat. No. 6,405,604, which is hereby incorporated by reference.

Even further according to the present invention, the method may include measuring the viscosity of the multi-phase fluid.

The differential pressure element may comprise a venturi having a converging section, a throat section and a diverging section.

In one form of the present invention there may be more than two differential pressure measurement devices placed in the conduit.

According to a third aspect of the present invention there is provided an in-line method for determination of the mass flow rate of a multi-phase fluid flowing through a conduit, the method comprising: directly calculating the Reynolds number and the discharge coefficient by means of the processor in an apparatus as described above; and calculating the mass flow rate by means of the processor, and by using the calculated Reynolds number and discharge coefficient.

Further aspects of the present invention will be apparent from the following description.

### BRIEF DESCRIPTION OF THE DRAWINGS

To assist those of ordinary skill in the relevant art in making and using the subject matter hereof, reference is made to the appended drawings, which are not intended to be drawn to scale, and in which like reference numerals are intended to refer to similar elements for consistency. For purposes of clarity, not every component may be labeled in every drawing.

FIG. 1 depicts a schematic side view of a prior art venturi flow meter. The venturi flow meter comprises an inlet pipe, convergent section, throat, divergent, and outlet pipe. The differential pressure is measured between the inlet pipe and the throat.

FIG. 2 depicts a prior art chart of an empirical relationship for the discharge coefficient as a function of Reynolds number. The chart is used to read-off the value of discharge coefficient corresponding to a Reynolds number according to the prior art.

FIG. 3 depicts a prior art flow diagram of the iterative procedure followed for the calculation of the mass flow rate of a fluid using a prior art venturi flow meter. This flow diagram depicts the prior art procedure to obtain mass flow rate in a viscous, low Reynolds number, fluid flow.

FIG. 4 depicts a schematic side view of an apparatus having a supplementary differential pressure measurement between throat and downstream region of a venturi according to an aspect of the present invention. The density of the fluid can be measured by an independent device located in the throat or at another location.

FIG. 5 depicts a chart of an empirical relationship for the Reynolds number as a function of Δp₂/Δp according to an aspect of invention.

FIG. 6 depicts a flow diagram of the direct procedure for mass flow rate determination according to an aspect of the present invention. The flow diagram depicts the steps required to determine the mass flow rate including the use of the explicit curve expressing the Reynolds number, Re as a function of the quotient Δp₂/Δp.

FIG. 7 depicts a schematic side view of an apparatus having a supplementary differential pressure measurement between a position on convergent region and throat of a venturi according to another aspect of the present invention.

FIG. 8 depicts a chart of an empirical relationship for Reynolds number as a function of Δp₃/Δp according to another aspect of the present invention.

FIG. 9 depicts a schematic side view of an apparatus having a supplementary differential pressure measurement between upstream and downstream pipe work from a venturi according to another aspect of the present invention.

FIG. 10 depicts a chart of an empirical relationship for Reynolds number as a function of Δp₄/Δp according to another aspect of the present invention.

### DETAILED DESCRIPTION OF THE INVENTION

The present invention provides an apparatus and method for measuring the mass flow rate (qₘ) of a multi-phase fluid flow. The apparatus and the method are particularly useful for high viscosity multi-phase fluids.

The apparatus according to the present invention is an in-line apparatus and it is used to determine the Reynolds number, Re, and the discharge coefficient, C_{d}, of a venturi applied to multi-phase fluid flow, and based on using multiple pressure differentials. Preferably, a single venturi tube and at least two pressure differential measurements are used to determine the Reynolds number and discharge coefficient, and from those variables the mass flow rate, qₘ, of the multi-phase fluid flow may be determined.

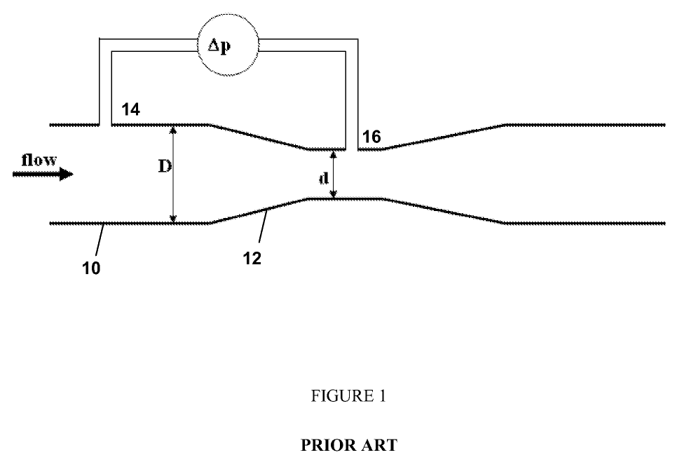

A schematic side view of a prior art example of a conduit 10 having a venturi 12 and the associated differential pressure measurement, Δp, is shown in FIG. 1. The differential pressure is measured by a pressure sensor 14 near the conduit taking a pressure measurement of the fluid and a pressure sensor 16 near the venturi taking a pressure measurement of the fluid, and then a calculation being made of the change in the pressure between these two positions. In this example, the mass flow-rate, qₘ, is calculated from the differential pressure measurement, Δp, using the known relationship:

$${q}_{m} = \frac{{C}_{d} {S}_{f} ɛ {A}_{d}}{\sqrt{1 - {β}^{4}}} \sqrt{2 ρ Δ p} \qquad ( 1 )$$

where, C_{d}, is the discharge coefficient, S_{f}, is the multi-phase flow regime parameter, ε is the gas expansion factor, β=d/D, A_{d}=πd²/4, ρ is the fluid density, d is the throat diameter and D is the inlet pipe diameter. Typically the density may be measured by a number of well known techniques such as but not limited to sampling, a nuclear densitometer, such as gamma ray attenuation, or using an equation of state to infer density from pressure and temperature.

It is generally accepted that the discharge coefficient, C_{d} , is a function of the Reynolds number, Re, as shown below:

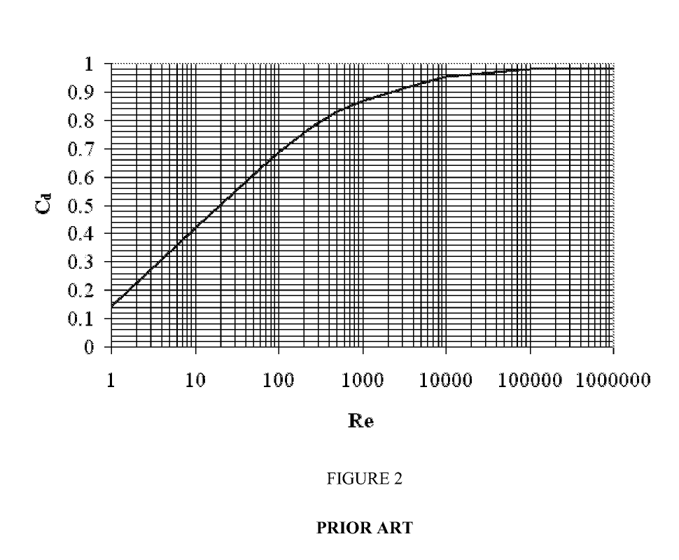

C_{d}=f (Re) (2)

where Re=ρUD/μ=4qₘ/πDμ, μ is the fluid viscosity and U is the mean fluid velocity measured at a cross section of the inlet pipe having a diameter D. The relationship in equation (2) is determined experimentally. An example of a typical empirical curve for discharge coefficient as a function of Reynolds number is shown in FIG. 2. It can be seen that the discharge coefficient is not constant and that the variation becomes significant at low Reynolds numbers that are indicative of highly viscous fluids.

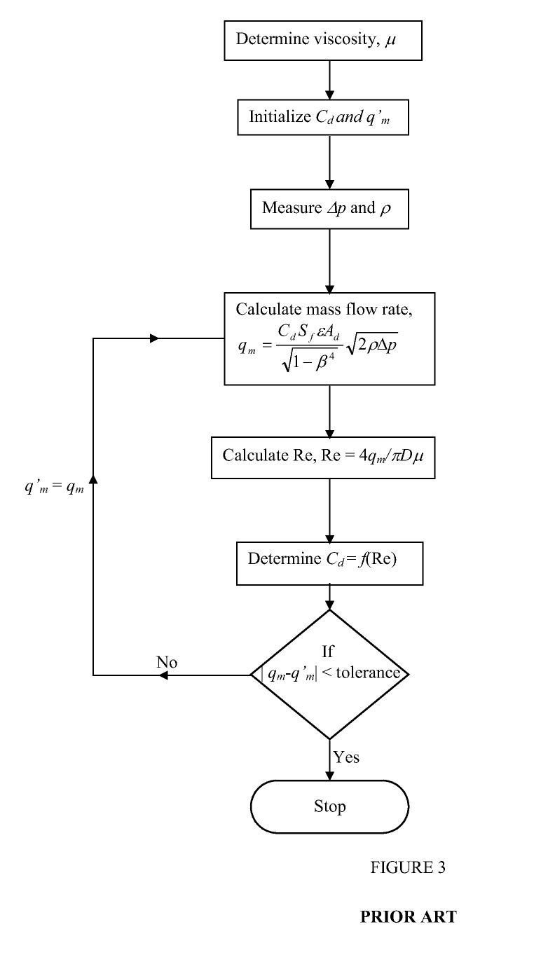

The mass flow rate for this example discussed above is determined by using an iterative method, as shown in the flow diagram of FIG. 3. The procedure assumes knowledge or measurement of the viscosity of the fluid. The discharge coefficient and mass flow rate is initialised before an iterative procedure is applied to determine the mass flow rate taking into account the effect of Reynolds number on the discharge coefficient. The differential pressure and density of the fluid are measured. As described in U.S. Pat. No. 6,405,604, which is incorporated herein by reference, the density of the multi-phase fluid may be measured by gamma ray attenuation at a first energy level at a frequency f₂ that is high relative to said frequency of gas/liquid alternation in a slug flow regime, and the mean of the measurements obtained in this way over each period t₁ corresponding to the frequency f₁ is formed to obtain said mean density value.

The mass flow rate is updated, allowing subsequent calculation of the Reynolds number and discharge coefficient. If the mass flow rate is not converged then the mass flow rate is re-calculated followed by a re-calculation of Reynolds number and re-determination of discharge coefficient. The iteration loop is repeated until convergence of the mass flow rate is obtained.

The viscosity can be determined when in a controlled environment or under laboratory conditions. However, in field conditions the requirement for sampling and measurement of viscosity are becoming more difficult and challenging, since corrections are required to be applied to the measured viscosity of the sample due to differences between line and sample temperature, pressure and effects of dissolved gas.

In multi-phase fluid flow and wet gas fluid flow applications the determination of viscosity is further complicated by the presence of several phases in the fluid. The viscosity of a mixture of oil and water could lead to a mixture having a viscosity several times higher than the viscosity of the oil on its own, due to emulsion effects. Thus the phase volume fractions become further necessary parameters for the characterisation of the viscosity.

The current invention provides an apparatus and the method for in-line determination of the mass flow rate of a multi-phase fluid flowing through a conduit. The in-line determination of the mass flow rate is obtained from the in-line determination of discharge coefficient and Reynolds number, which are in turn obtained from the measurement of at least two fluid differential pressures measured across a venturi by means of two or more differential pressure measurement devices.

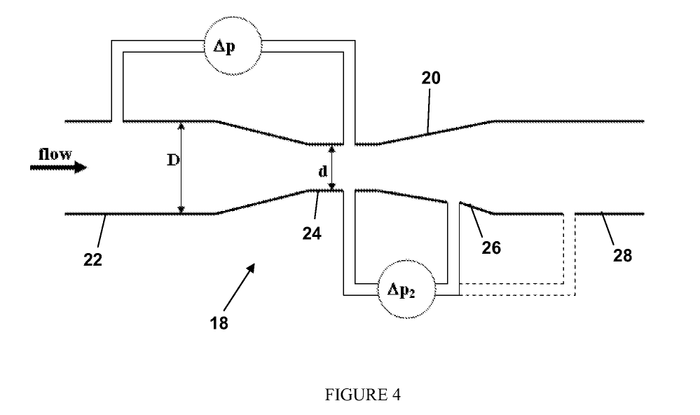

An apparatus 18 according to a first embodiment of the present invention is shown in FIG. 4. Apparatus 18 includes a differential pressure element, such as a venturi 20 with a fluid differential pressure measurement, Δp, made by a first differential pressure measurement device (not shown). The differential pressure measurement, Δp, is taken at the cross-section of the inlet pipe 22, upstream of the venturi 20, having a diameter D and the cross-section of throat 24 of the venturi 20 having a diameter d. It also includes a supplementary second fluid differential pressure measurement, Δp₂, taken by a second differential pressure measurement device (not shown). The differential pressure measurement, Δp, is taken between the cross-section of the throat 24 having a diameter d and the cross-section in the diverging section 26 of the venturi 20 downstream of the throat 24. Alternatively, as shown in FIG. 4, the second differential pressure measurement can be taken between the throat 24 of the venturi 20 and the outlet pipe 28 having a cross section D.

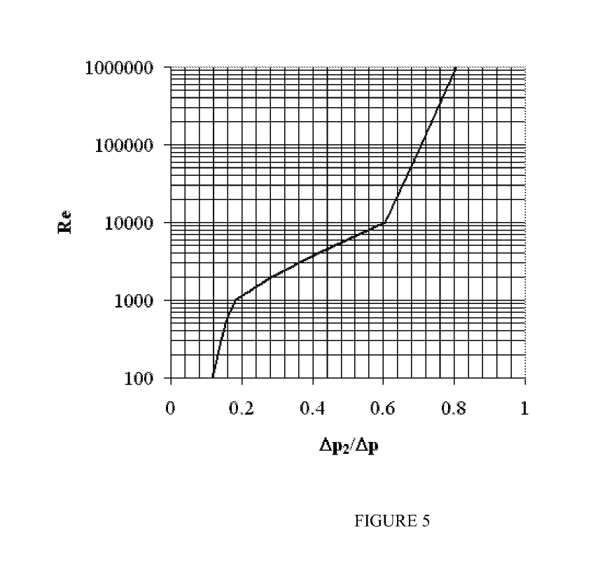

FIG. 5 depicts a chart of an empirical relationship for the Reynolds number as a function of Δp₂/Δp. This chart provides a means by which to determine the Reynolds number for the apparatus 18 as shown in FIG. 4. The chart belongs to one venturi or differential pressure element configuration and is applicable to a range of fluid properties and fluid flow regimes. The chart in FIG. 5 can be obtained experimentally by measuring Δp, Δp₂, qₘ, ρ and μ under controlled conditions. This data can then by transformed to provide a chart where Re=g(Δp₂/Δp).

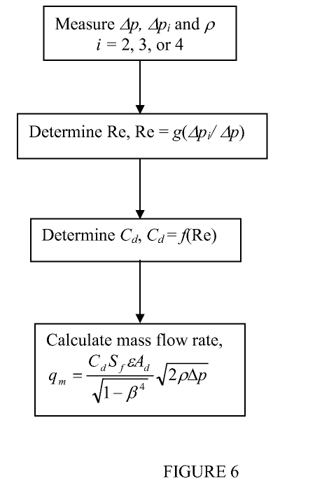

The present invention also provides an improved apparatus and method for measuring the mass flow rate of a highly viscous multi-phase fluid. The method includes the steps as shown in the flow chart of FIG. 6. Firstly the measurements of Δp, Δp₂ and ρ are carried out using the apparatus 18, as shown in FIG. 4. The Reynolds number is then determined using the relationship, Re=g(Δp₂/Δp), which is created as discussed previously. The discharge coefficient is then determined by using the relationship, C_{d}=ƒ(Re). The mass flow rate can then be calculated by using Equation (1).

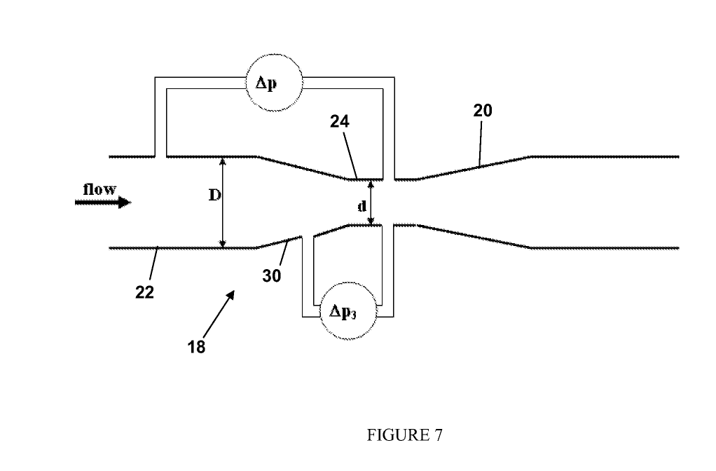

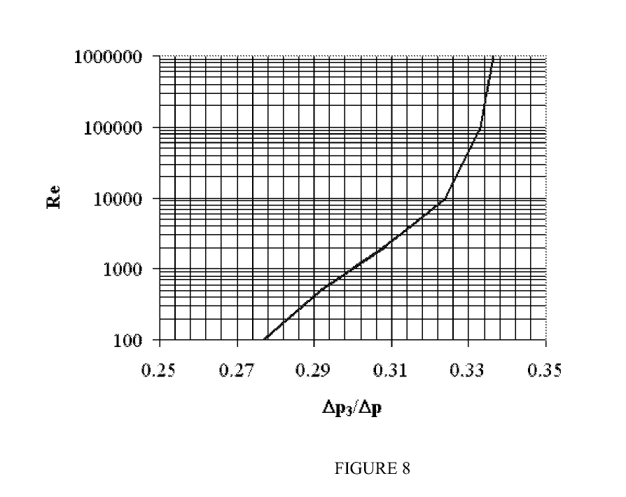

FIG. 7 depicts a second embodiment of the apparatus according to the present invention. In this configuration, apparatus 18 also includes a venturi 20 with a fluid differential pressure measurement, Δp, which is taken by a first differential pressure measurement device (not shown), at the cross-section of the inlet pipe 22 having a diameter D and the cross-section of throat 24 of the venturi 20 having a diameter d. Apparatus 18 further includes a second fluid differential pressure measurement, Δp₃, which is taken by a second differential pressure measurement device (not shown), between the inlet pipe 22 of diameter D and the converging section 30 situated upstream of the throat 24. FIG. 8 depicts a chart of an empirical relationship for Reynolds number as a function of Δp₃/Δp for this second embodiment of the present invention. This chart provides means by which to determine the Reynolds number. The chart is also determined experimentally, similarly to that as described for the first embodiment of the present invention.

The method by which to determine the mass flow rate in the first embodiment of the apparatus according to the present invention is similar to that of the second embodiment of the apparatus according to the present invention. The same flow chart is used for the procedure, but the Reynolds number relationship for the second embodiment of the apparatus is now Re=g(Δp₃/Δp).

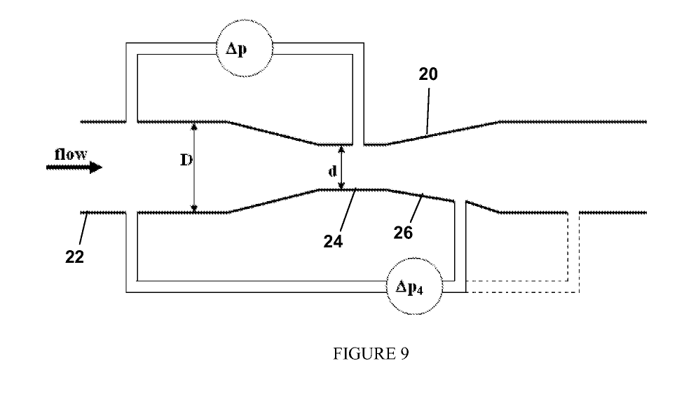

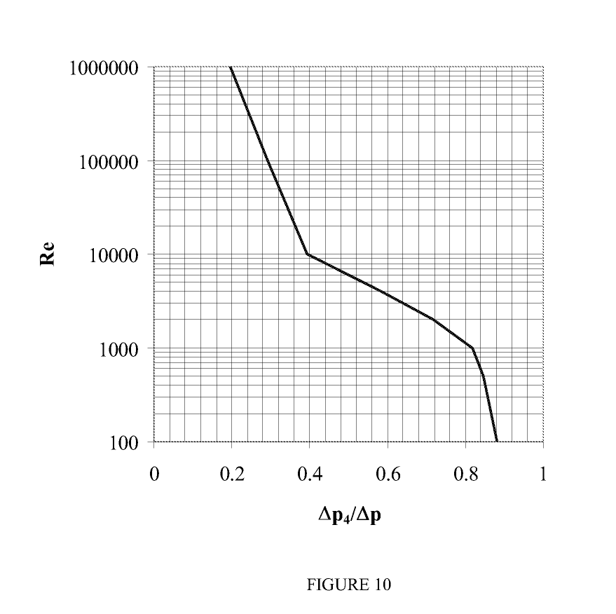

A third embodiment of the apparatus according to the present invention is shown in FIG. 9. In this configuration apparatus 18 also includes a venturi 20 with a fluid differential pressure measurement, Δp, which is taken by a first differential pressure measurement device (not shown), at the cross section of the inlet pipe 22 having a diameter D and the cross-section of throat 24 of the venturi 20 having a diameter d. Apparatus 18 further includes a second fluid differential pressure measurement, Δp₄, which is taken by a second differential pressure measurement device (not shown), between a position upstream at the cross section of the inlet pipe 22 and at the cross-section in the diverging section 26 of the venturi 20 downstream of the throat 24. FIG. 10 depicts a chart of an empirical relationship for Reynolds number as a function of Δp₄/Δp for this third embodiment of the present invention. This chart also provides means to determine the Reynolds number, and it is also determined experimentally, similarly to that discussed in the first embodiment of the apparatus according to the present invention.

The method by which the mass flow rate is determined when using the apparatus of the third embodiment of the present invention is similar to that of the method by which the mass flow rate is determined when using the apparatus of the first embodiment of the present invention. The same flow chart is used for the procedure, but the relationship for determining the Reynolds number is now Re=g(Δp₄/Δp).

The apparatus and method for determination of the mass flow rate of a multi-phase fluid flowing through a conduit according to the present invention may also incorporate the determination of the discharge coefficient and Reynolds number by using a plurality of supplementary differential pressure measurements. The differential pressure element of the apparatus may also comprise other well-known differential pressure elements, for example, V-cones, wedges or nozzles.

This invention does not pre-suppose the orientation of the apparatus. The meter could be orientated at the horizontal, the vertical or it may be inclined. The hydrostatic effect in the apparatus could also be corrected at any time.

This invention is versatile and is applicable to fluid flow measurement in general and more particularly in the oil and gas, as well as the food industries.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. An apparatus for measuring a mass flow rate of a multi-phase fluid flowing through a conduit, the apparatus comprising:
a differential pressure element located in a conduit;
a first differential pressure measurement device in communication with said multi-phase fluid between a first position and a second position across said differential pressure element for measuring a first fluid differential pressure;
a second differential pressure measurement device in communication with said multi-phase fluid between a third position and a fourth position across said differential pressure element for measuring a second fluid differential pressure;
a processor in communication with said first and second differential pressure measurement devices for receiving said first and second fluid differential pressures, respectively, said processor calculating a Reynolds number and a discharge coefficient using said first and second fluid differential pressures; and said processor calculating a mass flow rate by using said calculated Reynolds number and discharge coefficient.

2. The apparatus of claim 1, wherein said multi-phase fluid comprises water, oil, and gas.

3. The apparatus of claim 1, wherein said differential pressure element comprises a venturi having a converging section, a throat section and a diverging section.

4. The apparatus of claim 1, wherein said apparatus comprises more than two differential pressure measurement devices.

5. The apparatus of claim 3, wherein said first position of said first differential pressure measurement device is upstream of said venturi.

6. The apparatus of claim 3, wherein said second position of said first differential pressure measurement device is at said throat section of said venturi.

7. The apparatus of claim 3, wherein said third position of said second differential pressure measurement device is at said throat section of said venturi.

8. The apparatus of claim 3, wherein said fourth position of said second differential pressure measurement device is between said throat section and said diverging section of said venturi.

9. The apparatus of claim 3, wherein said fourth position of said second differential pressure measurement device is between said throat section of said venturi and said diverging section of said venturi downstream of said throat section.

10. The apparatus of claim 3, wherein said third position of said second differential pressure measurement device is between upstream of said venturi and said converging section situated upstream of said throat of said venturi.

11. The apparatus of claim 10, wherein said fourth position of said second differential pressure measurement device is at said throat section of said venturi.

12. The apparatus of claim 3, wherein said third position of said second differential pressure measurement device is upstream of said venturi.

13. The apparatus of claim 12, wherein said fourth position of said second differential pressure measurement device is between said throat section of said venturi and said diverging section of said venturi.

14. The apparatus of claim 12, wherein said fourth position of said second differential pressure measurement device is between said throat section of said venturi and said diverging section of said venturi downstream of said throat section.

15. The apparatus of claim 1, wherein said differential pressure element is selected from the group consisting of a V-cone, a wedge and a nozzle.

16. A method for determining a mass flow rate of a multi-phase fluid flowing through a conduit using an apparatus as in any one of the preceding claims, wherein the method comprises the steps of:
directly calculating the Reynolds number and the discharge coefficient by means of the processor; and
calculating a mass flow rate by means of the processor, and by using the calculated Reynolds number and discharge coefficient.

17. A method for determining a mass flow rate of a multi-phase fluid flowing through a conduit, the method comprising the steps of:
positioning a differential pressure element in a conduit;
measuring a first differential pressure between a first position and a second position across said differential pressure element by means of a first differential pressure measurement device;
measuring a second differential pressure between a third position and a fourth position across said differential pressure element by means of a second differential pressure measurement device;
processing said first differential pressure and said second differential pressure by means of a processor connected to said first and said second differential pressure measurement devices;
calculating a Reynolds number and a discharge coefficient by means of said processor; and
calculating said mass flow rate by means of said processor, and by using said Reynolds number and said discharge coefficient.

18. The method of claim 17, further comprising the step of measuring a density of said multi-phase fluid.

19. The method of claim 18, in which said density is measured by gamma ray attenuation.

20. The method of claim 17, further comprising the step of measuring a viscosity of said multi-phase fluid.

21. The method of claim 17, in which said multi-phase fluid comprises water, oil, and gas.

22. The method of claim 17, in which said differential pressure element comprises a venturi having a converging section, a throat section and a diverging section.

23. The method of claim 17, in which there is more than two differential pressure measurement devices.
